(19) United States
(12) Patent Application Publication
(10) Pub. No.: US 2026/0291429 A1
(43) Pub. Date: Sep. 24, 2026

(54) SOLAR TRACKER DEFECT INSPECTION USING ROBOTIC PROCURED DATA

(71) Applicant: Nextpower LLC, Fremont, CA (US)

(72) Inventors: Jitendra Morankar, San Ramon, CA (US); Akshay Keshav Roge, Mumbai (IN)

(21) Appl. No.: 19/567,793

(22) Filed: Mar. 16, 2026

Related U.S. Application Data
(60) Provisional application No. 63/775,461, filed on Mar. 21, 2025.

(51) Int. Cl. H02S 40/10; G01C 9/02; G01J 1/42; H02S 20/32

(52) U.S. Cl. CPC H02S 40/10; G01C 9/02; G01J 1/42; H02S 20/32; G01J 2001/4266

(57) ABSTRACT

A robotic thermal inspection system includes a robotic body and solar tracker inspection module. The robotic body includes a controller and a sensor device coupled to the controller. The solar tracker inspection module is in communication with the sensor device and includes a programmable processor that executes instructions to cause the programmable processor to: receive, from the sensor device, sensor data related to a solar tracker component, compare this sensor data to at least one predetermined solar tracker component threshold, and, when this sensor data meets the at least one predetermined threshold, provide a solar tracker defect indication.

### RELATED APPLICATIONS

This application claims the benefit of U.S. Provisional Patent Application No. 63/775,461, filed Mar. 21, 2025, the entire contents of which are incorporated herein by reference.

### TECHNICAL FIELD

This disclosure relates generally to robotic inspection of one or more solar tracker components. Embodiments disclosed herein describe inspection of solar tracker components by procuring sensor data relating to such solar tracker components using a robotic body that moves along the solar tracker and then comparing that procured sensor data to one or more predetermined thresholds that relate to the solar tracker component(s). In this way, defects relating to the solar tracker component can be predicted and/or identified.

### BACKGROUND

Photovoltaic (PV) systems are an essential part of renewable energy infrastructure, converting sunlight into electricity to meet growing energy demands sustainably. PV systems, commonly installed as ground-mounted solar farms or rooftop arrays, rely on exposure of photovoltaic cells at one or more photovoltaic modules (“solar modules”) to sunlight to convert this irradiated sunlight into electrical energy. However, if one or more photovoltaic modules have certain defects, power generation capability can be degraded or become nonfunctional.

Given the number of photovoltaic modules utilized at utility-scale solar farms (e.g., solar tracker systems), manual inspection of individual photovoltaic modules can be labor-intensive and time-consuming. Thus, this can make the cost of routinely, manually inspecting photovoltaic modules impractical. Yet, without routinely inspecting the photovoltaic modules for defects, such as those that can interfere with or prevent energy generation capability, the efficiency and function of a solar system can be degraded.

### SUMMARY

The present disclosure describes exemplary embodiments relating to robotic inspection of solar trackers. In particular, this disclosure describes exemplary applications for procuring sensor data relating to one or more solar tracker components while a robotic body moves along the solar tracker and then using that procured data to identify and/or predict one or more defects at the solar trackers, such as one or more defects relating to the solar tracker component to which the procured sensor data relates. Such embodiments can help to improve the operational longevity and reliability of the solar tracker by enabling efficient, utility-scale preventive maintenance, quality assurance (e.g., as associated with installation of solar tracker components and/or commissioning of the solar tracker), and/or solar tracker energy generation performance monitoring.

Examples disclosed herein include robotic inspection devices, systems, and methods for inspecting one or more solar tracker components. Such devices, systems, and methods for robotically inspecting PV modules as disclosed herein can be autonomous or semi-autonomous, and such embodiments disclosed herein can utilize one or more machine learning algorithms to leverage the procured sensor data to identify sensor data correspondence and/or sensor data patterns, for instance relating to a particular solar tracker component, over time to thereby provide one or more defect indications for remediation. By integrating one or more sensor devices, such as a camera (e.g., visible light camera), proximity sensor, and/or accelerometer, at a robotic vehicle that is movable along a solar tracker, and relative to PV modules thereat, embodiments disclosed herein can enable predictive and/or substantially real-time potential solar tracker defects.

Robotic inspection embodiments disclosed herein can be particularly advantageous for utility-scale solar trackers. By partially or fully automating solar tracker component inspection and/or maintenance tasks, embodiments disclosed herein can reduce operational costs, increase energy yields, and extend the lifespan of solar panels. For example, embodiments disclosed herein can identify defects by identifying loose component assemblies, missing fasteners, loose fasteners, incorrect cabling, corrosion impact, improper torque application, and/or other installation and/or commissioning flaws that deviate from a predetermined baseline threshold. Such identified defects can be flagged and reported for potential remediation prior to such defects materially degrading energy generation capability. As one example, the robotic vehicle can procure sensor data relating to installation of a solar tracker component (e.g., data relating to a presence/absence and/or position of a component relative to the solar tracker), and this procured sensor data can then be used to identify one or more installation defects relating to that solar tracker component. As another additional or alternative example, the robotic vehicle can procure sensor data relating to a variation over time pertaining to the solar tracker component (e.g., data indicating the solar tracker component has changed relative position at the solar tracker (e.g., disappeared) and/or deviates from a predetermined threshold), and this procured sensor data can then be used to identify one or more defects occurring after installation and during operation of the solar tracker. For instance, certain embodiments disclosed herein include inspecting solar tracker components using one or more sensor device carried at a robotic body that is movable relative to (e.g., along) a row of the solar tracker. For instance, the robotic body can be configured to traverse in a first direction at a first time over surfaces of photovoltaic modules along a row of a solar tracker to capture first sensor data relating to components along the row of a solar tracker, and then the robotic body can be configured to traverse in a second, opposite direction at a second, later time over surfaces of photovoltaic modules along the row to capture second sensor data relating to the components along the row of the solar tracker.

In some embodiments, the devices, systems, and methods can be further configured to, in addition to inspection of PV modules using one or more sensor devices, execute one or more maintenance operations at one or more PV modules (e.g., when traversing the row). For instance, these devices, systems, and methods disclosed herein can be configured to execute a maintenance operation at one or more PV modules by at least sweeping a surface of one or more PV modules, applying a coating material to a surface of one or more PV modules, and/or applying a fluid cleaning solution (e.g., pressurized air, liquid cleaning solution, such as water and/or detergent, and/or an atomized mixture of liquid cleaning solution and pressurized air) to a surface of the one or more PV modules. By executing such a maintenance operation at one or more PV modules in conjunction with data procurement for inspecting such one or more PV modules and/or other solar tracker components, embodiments disclosed herein can enable higher integrity data procurement and, thus, more accurate inspection by reducing the impact of particulate on the solar tracker when inspecting. This can also allow embodiments disclosed herein to evaluate the effectiveness of the maintenance operation. Thus, embodiments disclosed herein can use advanced mechanisms, such as soft brushes, air blowers, or dry cleaning techniques, to remove debris efficiently and sustainably. And, for instance, embodiments disclosed herein (e.g., robotic body) can be equipped with smart sensors, machine learning algorithms, and/or remote monitoring capabilities, and thereby can provide a reliable, efficient, and cost-effective solution for inspecting solar tracker component installation and/or solar tracker performance.

One embodiment includes a robotic inspection system. This system includes a robotic body and a solar tracker inspection module. The robotic body includes a controller, a motive source coupled to the controller, a sensor device coupled to the controller, a brush assembly coupled to the controller, and an attachment mechanism for attaching the robotic body to a solar tracker such that the robotic body is configured to move along the solar tracker with the brush assembly disposed to interface with a first side of the solar tracker. The solar tracker inspection module is in communication with the sensor device. The solar tracker inspection module includes a programmable processor and a non-transitory computer-readable medium storing instructions that, when executed by the programmable processor, cause the programmable processor to: receive, from the sensor device, sensor data related to at least one solar tracker component of the solar tracker, compare the received sensor data to at least one predetermined solar tracker component threshold, and, when the received sensor data meets the at least one predetermined solar tracker component threshold, provide a solar tracker defect indication.

In a further embodiment of this system, the sensor device can include an imaging device, and the sensor data received from the imaging device can include visible light image data that relates to the at least one solar tracker component. For example, the imaging device can be disposed at the robotic body to capture the visible light image data at least at a second side of the solar tracker, the second side opposite the first side to which the brush assembly is disposed to interface. In one particular such example, the imaging device can include a first visible light camera and a second visible light camera, with the first visible light camera disposed at a first side of the robotic body such that the first visible light camera is configured to capture first visible light image data at least of the second side of the solar tracker in an eastward-facing direction, and the second visible light camera disposed at a second, opposite side of the robotic body such that the second visible light camera is configured to capture second visible light image data at least of the second side of the solar tracker in a westward-facing direction. For instance, the solar tracker inspection module can be configured to combine the first visible image data with the second visible image data to form a composite visible light data map that comprises the at least one solar tracker component at the second side of the solar tracker. In certain cases, the brush assembly can include a brush member that extends from a first brush end of the brush member adjacent to the first visible light camera to a second, opposite brush end of the brush member adjacent to the second visible light camera.

According to some exemplary applications of this system embodiment, the at least one solar tracker component at the second side of the solar tracker can be a first solar tracker component that comprises at least one of: a wire harness, a cable string, a torque tube, a fastener, and a ground support. And the at least one predetermined solar tracker component threshold can include a predetermined position of the first solar tracker component relative to a second, different solar tracker component that is at the second side of the solar tracker.

In a further embodiment of this system, the sensor device includes an accelerometer, and the sensor data received from the accelerometer can relate to an orientation of the at least one solar tracker component when the robotic body is at the solar tracker component. For example, in one application, the at least one solar tracker component can include a photovoltaic module of the solar tracker, and the at least one predetermined solar tracker component threshold can include data relating a programmed inclination angle of the photovoltaic module when the robotic body is at the photovoltaic module. When executed by the programmable processor, the instructions cause the programmable processor to compare the received sensor data from the accelerometer relating to the orientation of the photovoltaic module to the programmed inclination angle of the photovoltaic module, and, when the received sensor data from the accelerometer differs from the programmed inclination angle of the photovoltaic module, provide the solar tracker defect indication.

In a further embodiment of this system, the sensor device includes a proximity sensor, and the sensor data received from the proximity sensor can relate to: (i) a first distance between the proximity sensor and the at least one solar tracker component at a first time when the robotic body is at the solar tracker component, and (ii) a second distance between the proximity sensor and the at least one solar tracker component at a second, different time when the robotic body is at the solar tracker component. The at least one predetermined solar tracker component threshold can include a predetermined magnitude of change between the first distance and the second distance such that, when executed by the programmable processor, the instructions cause the programmable processor to provide the solar tracker defect indication when the sensor data received from the proximity sensor meets the predetermined magnitude of change. As one such example, the at least one solar tracker component can include a photovoltaic module, the brush assembly can include a brush member, and the proximity sensor can be disposed at the robotic body to capture the sensor data after the brush member has passed over the photovoltaic module. In other additional or alternative examples, the proximity sensor can include a plurality of proximity sensing members disposed along a first axis relative to the robotic body, and the brush assembly can be disposed along a second axis relative to the robotic body, with this second axis parallel to the first axis.

In a further embodiment of this system, when executed by the programmable processor, the instructions further cause the programmable processor to: calibrate the sensor device based on at least one environmental condition ambient to the robotic body. For example, when executed by the programmable processor, the instructions further cause the programmable processor to: determine a presence of solar light irradiance at the photovoltaic module exceeding a predetermined irradiance threshold, and when the presence of solar light irradiance at the photovoltaic module is determined to exceed a solar light irradiance threshold, adjust an orientation of the sensor device, relative to the robotic body, to reduce solar light irradiance captured by the sensor device.

In a further embodiment of this system, when executed by the programmable processor, the instructions further cause the programmable processor to: receive weather data relating to an ambient weather condition at the solar tracker and save the weather data in association with the solar tracker defect indication.

In a further embodiment of this system, the solar tracker inspection module can be at a server remote from the robotic body, and wherein the sensor device is in wireless data communication with the solar tracker inspection module. In another alternative or additional embodiment, the solar tracker inspection module can onboard the robotic body.

In a further embodiment of this system, the robotic body further includes a maintenance solution applicator configured to apply a maintenance solution, via the maintenance solution applicator, to the solar tracker. This maintenance solution applicator can include a plurality of nozzles disposed along a first axis relative to the robotic body, and the brush assembly can be disposed along a second axis relative to the robotic body, with the second axis parallel to the first axis.

Anther embodiment include a method of inspecting a solar tracker. This method embodiment includes the steps of: attaching a robotic body to the solar tracker; sweeping a surface of a photovoltaic module of the solar tracker using a brush assembly at the robotic body while moving the robotic body along the solar tracker; while moving the robotic body along the solar tracker, using a sensor device at the robotic body to acquire sensor data relating to at least one component of the solar tracker other than the photovoltaic module; comparing the sensor data to at least one predetermined solar tracker component threshold; and when the sensor data meets the at least one predetermined solar tracker component threshold, providing a solar tracker defect indication

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings.

FIG. 1 is a perspective view of an embodiment of a solar tracker system.

FIG. 2 is a schematic, top view of a solar tracking system arranged in rows of continuous trackers spaced apart from one another, with a robotic inspection system inspecting one or more components of the solar tracker as a robotic body moves along the row.

FIGS. 3A-3C illustrate an embodiment of a robotic body that can be part of a robotic inspection system, such as that of FIG. 2. FIG. 3A is a block diagram of this embodiment of the robotic body, FIG. 3B is a perspective view at one side of this embodiment of the of the robotic body, and FIG. 3C is a perspective view at another, opposite side of this embodiment of the of the robotic body.

FIG. 4 is a flow diagram of an embodiment of method of inspecting a solar tracker.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

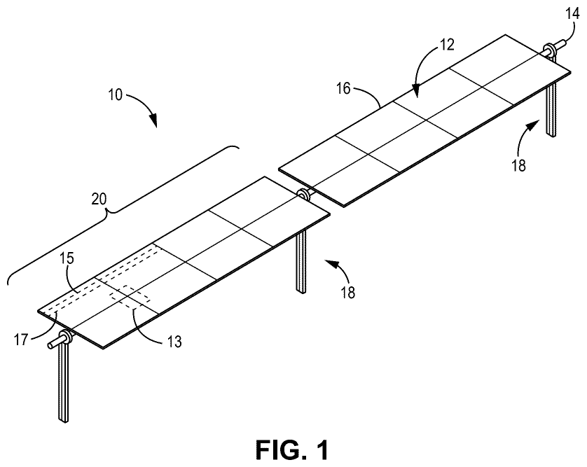

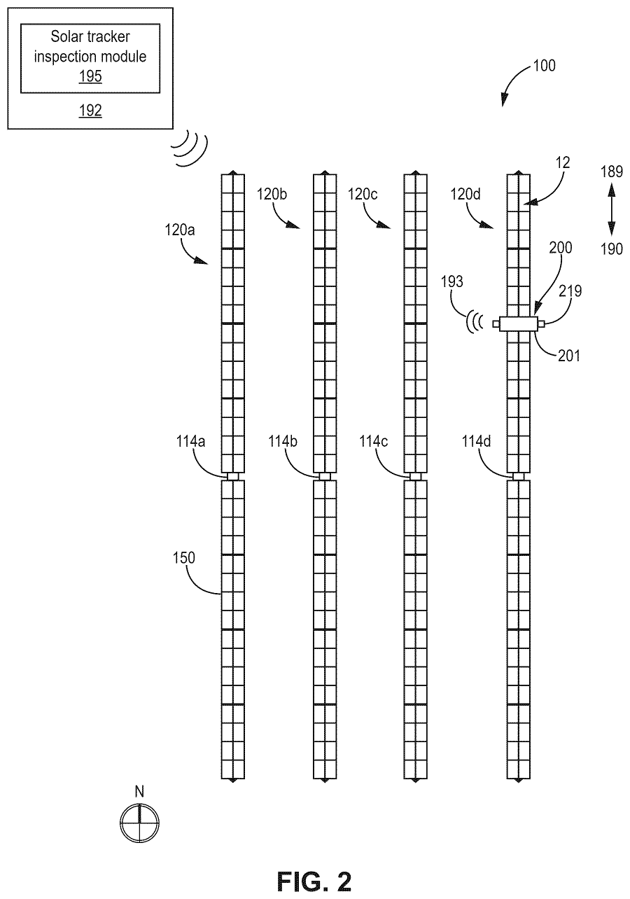

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array, such as illustrated at FIG. 2. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more PV modules (or “solar modules”) 12 mounted to the torque tube 14 such that the PV modules 12 can be oriented to a desired position. That desired position may be to a position to maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the PV modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the PV modules 12 must be supported on the torque tube 14. This is typically achieved by a fastening assembly 13 that couples the PV modules 12 to the torque tube 14 substantially perpendicular to the longitudinal axis of the torque tube 14. The fastening assembly 13 can be adjacent to a second side of the PV module 12 (e.g., in some orientations of the solar tracker an underside of the PV module 12) which is opposite a first side of the PV module 12 having PV cells. The torque tube 14 may be rotatable about its longitudinal axis to adjust an angular orientation of the PV modules 12 relative to the sun, while supporting the PV modules 12 on the fastening assembly 13. In addition, to transfer electrical energy generated at PV modules, electrical cable strings 15 can extend from the PV modules 12 to a common electrical storage medium at the solar tracker, and a wire harnesses 17 can be used to help retain the electrical cable strings 15 in place at the solar tracker while the torque tube 14 is rotated.

Each PV module 12 of the solar tracker 10 can include one or more PV cells that is configured to convert sunlight into electrical energy. Each PV module can have a plurality of PV cells disposed along on a laminate substrate, and the laminate substrate can be at least partially bounded by a frame. Thus, as sunlight irradiates onto the PV cells, the PV module can generate electrical energy.

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of ground support piers (not explicitly shown in FIG. 2). At the opposite side of the PV cells, can be fastening assemblies 13, wire harnesses 17, electrical string cables 15. The torque tube 14 may be an example of the torque tube 14, as in FIG. 1. As shown, the solar tracker rows 120 may be separated by a space sufficient to allow machinery to travel therethrough to allow for cleaning and maintenance.

As noted, robotic inspection system 200 and method embodiments described herein can perform at least a solar tracker inspection function by capturing sensor data related to one or more components of the solar tracker, such as ground supports, wire harnesses, cable strings, a torque tube, and/or fastening assemblies coupling together two or more solar tracker components. FIG. 2 shows a schematic illustration of a robotic inspection system 200 performing an inspection function by capturing sensor data related to one or more solar tracker components. To execute such a function, the system 200 can include a sensor device 219. As shown here, the sensor device 219 can be carried at the robotic body 201, and the robotic inspection system 200 (e.g., robotic body 201) can move relative to the row 120d of the solar tracker so as to traverse relative to solar tracker components of the given row 120d, such as in directions 189, 190. The direction 189 can be a north or south direction and the direction 190 can be the other of north and south such that the robotic inspection system 200 moves along the given row 120d in the north and/or south directions. For certain embodiments, the robotic inspection system 200 can be configured to move bi-directionally along the given row 120d such that the robotic inspection system 200 can be configured to move in both a north and a south direction along the given row 120d. As the robotic inspection system 200 is moved relative to a given row 120d, the robotic inspection system 200 can capture sensor data, via the sensor device 219, related to one or more components at the row 120d of the solar tracker as robotic body 201 moves along the row 120d. For instance, at shown at FIG. 2, when the robotic inspection system 200 is moved along one or more PV modules 12 in the direction 190, the robotic inspection system 200 can capture visible image data (e.g., via a visible light camera of the sensor device 219), orientation data (e.g., via an accelerometer/gyroscope of the sensor device 219), and/or proximity data (e.g., via a proximity sensor of the sensor device 219) along the row 120d in the direction 190.

As shown here, the sensor device 219 can be carried at the robotic body 201 such that the sensor device 219 can be selectively removed from the robotic body 201. Thus, the sensor device 219 could be a module hardware device that can be removably attached at the robotic body 201 when one or more desired inspection applications are to be carried out at the solar tracker.

This captured sensor data relating to one or more components of the solar tracker can be used to detect and/or predict one or more solar tracker defects. For instance, captured sensor data relating to one or more solar tracker components at an underside of the solar tracker (e.g., between the ground surface and the PV cells at the PV modules), such as ground supports, torque tubes, fastening assemblies, wire harnesses, and/or cable strings, can be procured and used to detect and/or predict one or more defects associated with such underside components. As one example, such captured sensor data at the sensor device 219 can be compared to one or more predetermined component thresholds, and, when this captured sensor data meets the one or more predetermined component thresholds, a solar tracker defect indication can be provided (e.g., by indicating a present component defect and/or by indicating a potential future component defect).

As shown in FIG. 2, the robotic inspection system 200 can be configured for communication with a remote server 192. In the illustrated example, the robotic inspection system 200 is in wireless communication 193 with the remote server 192. For example, the robotic inspection system 200, such as at robotic body 201, can include one or more remotely monitored components in data communication with the remote server 192. Accordingly, as the robotic inspection system 200 is operated to acquire sensor data relating to one or more solar tracker components, this sensor data from the robotic inspection system 200 can be communicated to the remote server 192. This can, for example, facilitate remote monitoring (e.g., real-time) and/or control of the robotic inspection system 200 via the remote server 192. In addition, in some cases, the robotic inspection system 200 can be in bi-directional communication with the remote server 192 such that the remote server 192 can transmit instructions or other data to the robotic inspection system 200, for instance, to actuate a control function at the robotic inspection system 200. In some embodiments, the robotic inspection system 200 can integrate with Supervisory Control and Data Acquisition (SCADA) system(s) to enable remote monitoring and control of the robotic inspection system 200. For example, the robotic inspection system 200 can be remotely monitored and controlled as to data capture via the sensor device 219 and/or executing one or more maintenance operations at the solar tracker using the robotic body 201 (e.g., coating material, water, and/or a cleaning solution and/or pressurized air) application metrics.

As noted, the robotic inspection system 200 can capture sensor data relating to one or more solar tracker components, and this captured sensor data can be used to identify and/or predicting solar tracker defects, such as loose component assemblies, missing fasteners, loose fasteners, incorrect cabling, corrosion impact, improper torque application, or other flaws that can be related to an installation of one or more solar tracker components. As one example, the captured sensor data relating to a solar tracker component (e.g., a relative position of this solar tracker component at the row) can be compared to one or more predetermined solar tracker component thresholds, and, when this captured sensor data meets the one or more predetermined thermal thresholds, a solar tracker defect indication can be provided (e.g., by indicating a present solar tracker component defect and/or by indicating a potential future solar tracker component defect).

A solar tracker inspection module 195 can be included at the robotic inspection system 200 to execute one or more solar tracker component inspections. The solar tracker inspection module 195 can include one or more programmable processors and one or more associated non-transitory computer readable mediums storing instructions that, when executed by the programmable processor, can cause the programmable processor of the solar tracker inspection module 195 to: receive, from the sensor device 219, sensor data related to at least one solar tracker component of the solar tracker, compare the received sensor data to at least one predetermined solar tracker component threshold, and, when the received sensor data meets the at least one predetermined solar tracker component threshold, provide a solar tracker defect indication. As one example, the provided solar tracker defect indication can include an indication relating to at least one of: a wire harness, a cable string, a torque tube, a fastener, and a ground support. As another additional or alternative example, the provided solar tracker defect indication can include an indication relating to a defective inclination angle, as indicated using the data from the sensing device 219, of a solar tracker component (e.g., a PV module) differing from a programmed inclination angle. As another additional or alternative example, the provided solar tracker defect indication can include an indication relating to a predetermined magnitude of change of a distance between solar tracker components to provide the solar tracker defect indication when the sensor data received from the sensing device 219 meets the predetermined magnitude of change. In some embodiments, the solar tracker inspection module 195 can store a machine learning model that is configured, when executed, to derive data patterns over time from the captured sensor data relating to one or more components at the solar tracker.

FIG. 2 shows an example where the solar tracker inspection module 195 is at the remote server 192, and thus remote from the robotic body 201, such that the solar tracker inspection module 195 can be in data communication (e.g., wireless data communication) with the robotic body 201. Though other examples can include the solar tracker inspection module 195 onboard the robotic body 201.

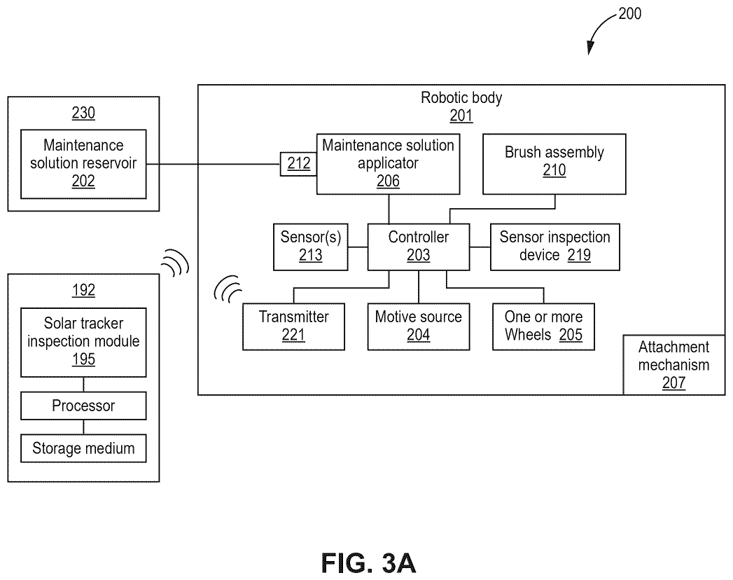

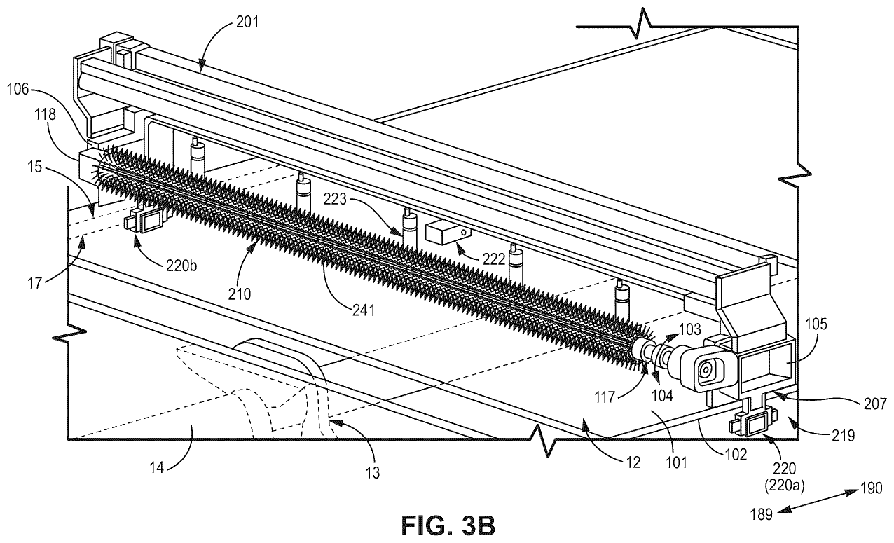

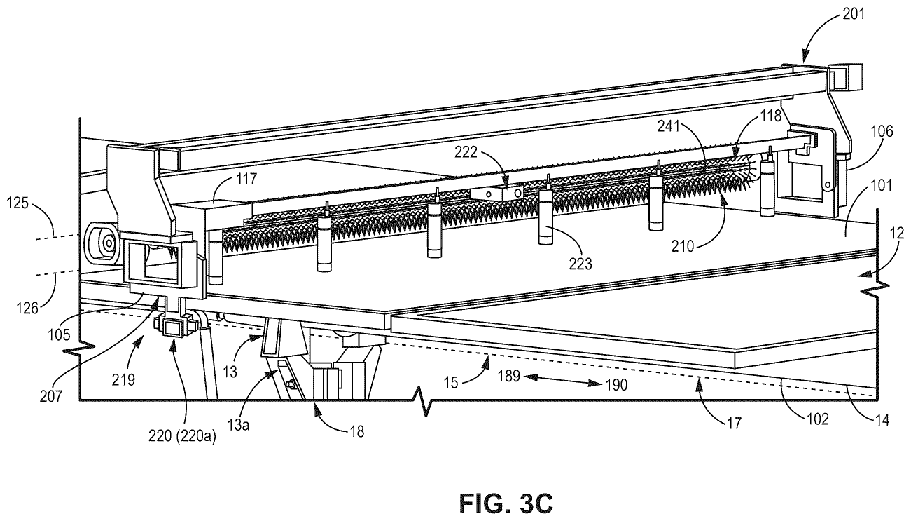

FIGS. 3A-3C illustrate an embodiment of robotic body 201 that can be part of the inspection system 200. FIG. 3A is a block diagram of this embodiment of the robotic body 201, FIG. 3B is a perspective view at one side of this embodiment of the of the robotic body 201, and FIG. 3C is a perspective view at another, opposite side of this embodiment of the of the robotic body 201. In particular, FIGS. 3B and 3C show the robotic body 201 at a portion of a row of a solar tracker such that the robotic body 201 can move along the row to capture sensor data relating to one or more components at that row of the solar tracker.

In addition to the robotic inspection system 200 including the solar tracker inspection module 195, the system 200 can include the robotic body 201. The embodiment of the robotic body 201 shown here can include at least a controller 203, a motive source 204 coupled to the controller 203, an attachment mechanism 207 for attaching the robotic body 201 to the solar tracker, and sensor device 219 coupled to the controller 203. This robotic body 201 example shown here also includes at least one brush assembly 210 coupled to the controller 203 and one or more wheels 205 coupled to the motive source 204. For example, the attachment mechanism 207 can be configured to attach the robotic body 201 to the solar tracker such that the robotic body 201 can move along the solar tracker with the brush assembly 210 disposed to interface with a first side 101 of the solar tracker, and the attachment mechanism 207 can be configured to attach the robotic body 201 to the solar tracker such that the sensor device 219 is disposed at the robotic body 201 to capture sensor data at a second side 102 of the solar tracker opposite the first side 101. As shown here, for example, the second side 102 can include fastening assemblies 13, wire harnesses 17, electrical string cables 15, torque tube 14, and ground support 18. The brush assembly 210 can be coupled to the controller 203 such that the controller can actuate the brush assembly 210 to cause a brush member 241 to rotate, in direction(s) 103, 104 relative to the robotic body 201, for instance, to perform a maintenance task at one or more PV modules 12 or other solar tracker component(s). For instance, the controller can actuate the brush assembly 210 to cause a brush member 241 to rotate relative to the robotic body 201 to sweep a surface of one or more PV modules 12 and/or to finish a coating at a surface of one or more PV modules 12.

FIGS. 3B and 3C show an example arrangement of components at robotic body 201. As one example shown here, the sensor device 219 can include one or more imaging devices 220. For example, the one or more imaging devices 220 can be visible light cameras, and the sensor data received from the one or more imaging devices 220 can include visible light image data that relates to the at least one solar tracker component. As illustrated here, the one or more imaging devices 220 can be disposed at the robotic body 201 to capture the visible light image data at least at the second side 102 of the solar tracker. As such, the one or more imaging devices 220 can capture image data relating to any one or more components at the second side 102 of the solar tracker. For instance, the second side 102 can include a first solar tracker component that includes at least one of: wire harness 17, a cable string 15, torque tube 14, fastening assemblies and/or fastening members 13, and ground support 18, and the at least one predetermined solar tracker component threshold can include a predetermined position of that first solar tracker component relative to a second, different solar tracker component that is at the second side 102 of the solar tracker. In this way, the image data captured by the imaging device 220 can be used to inspect for proper initial installation of such one or more components at the second side 102 and/or positional changes (e.g., over time of solar tracker operation) of one or more second side 102 components relative to one or more other solar tracker components (e.g., one or more other solar tracker components at the first side 101 and/or the second side 102.)

The embodiment of the robotic body 201 illustrated here has the imaging device 220 as including a first visible light camera 220a and a second visible light camera 220b. The camera 220a, 220b can be spaced apart from one another about the robotic body 201. The first visible light camera 220a can be disposed at a first side 105 of the robotic body 201 such that the first visible light camera 220a can be configured to capture first visible light image data at least of the second side 102 of the solar tracker in an eastward-facing direction, and the second visible light camera 220b can be disposed at a second, opposite side 106 of the robotic body 201 such that the second visible light camera 220b can be configured to capture second visible light image data at least of the second side 102 of the solar tracker in a westward-facing direction.

The solar tracker inspection module 195 can receive and use at least this underside image data from opposite, eastward and westward facing sides to compare to one or more predetermined solar tracker component thresholds. In some examples, the solar tracker inspection module 195 can be configured to combine the first visible image data from the first camera 220a with the second visible image data from the second camera 220b to form a composite visible light data map that comprises the at least one solar tracker component at the second side 102 of the solar tracker.

As also shown here, the brush assembly 210 can be indexed relative to the sensor device 219. For instance, the brush member 241 of the brush assembly 210 can extend from a first brush end 117 of the brush member 141 adjacent to the first visible light camera 220a to a second, opposite brush end 118 of the brush member 141 adjacent to the second visible light camera 220b. Accordingly, the brush member 141 can be disposed at the robotic body 201 to interface with the first side 101 (e.g., a surface of PV module 12 facing the sun) while the sensor device 219 (e.g., one or more cameras 220a, 220b) is disposed at the robotic body 201 to capture sensor data representing at least one solar tracker component at the second side 102.

As another example shown at FIGS. 3B and 3C, the sensor device 219 can include an accelerometer 222. For instance, the sensor device 219 can include the accelerometer 222 in addition to, or alternative to, imaging device(s) 220. In such cases, the sensor data received from the accelerometer 222 can relate to an orientation of at least one solar tracker component when the robotic body 201 is at the solar tracker component. For example, the sensor data received from the accelerometer 222 can relate to an orientation of PV module 12 at which robotic body 201 is positioned. Because torque tube 14 can rotate PV modules 12 according to a programmed inclination angle to orient the PV module 12 to track the position of the sun, at a given time the solar tracker can be programmed to orient the PV module 12 at a particular programmed inclination angle. Accordingly, this programmed inclination angle can be compared to the data captured by the accelerometer to detect a defect relating to a present orientation of the PV module 12. For instance, the at least one predetermined solar tracker component threshold can include such data relating a programmed inclination angle of the PV module 12 when the robotic body 201 is at the PV module 12, and, when executed by the programmable processor, the instructions at the module 195 can cause the programmable processor to compare the received sensor data from the accelerometer 222 relating to the orientation of the photovoltaic module when the robotic body 201 is at the PV module 12 to the programmed inclination angle of the PV module 12. When this received sensor data from the accelerometer 222 differs from the programmed inclination angle of the photovoltaic module 12, a solar tracker defect indication can be provided. As one particular example, the programmed inclination angle of the PV module 12 can be a forty degree stow position, but when the sensor data captured by the accelerometer 222 indicates the robotic body 201 at the PV module 12 is oriented at a different angular position that then forty degree stow position (e.g., a different angular position beyond a predetermined threshold magnitude), the module 195 can provide the defect indication. Such defect indication can indicate a defect pertaining to the fastening of the PV module 12 at the torque tube 14 as a function of the deviation between the present PV module 12 orientation as detected by the accelerometer 222 and the present programmed inclination angle.

The accelerometer 222 can procure multi-axis orientation data (e.g., corresponding to the present orientation of the robotic body 201 at the PV module 12) which can be useful in identifying one or more solar tracker defects. For example, the accelerometer 222 can continuously monitor the angular orientation of the robotic body 201, detecting any unexpected tilting or inclination beyond predetermined limits, which could indicate: PV module 12 warping or deformation, misaligned tracker components and/or uneven component installation, any unstable or slippery regions at the PV module 12, and/or twisting (e.g., excessive twisting of the torque tube about the torque tube's central longitudinal axis). As another example, accelerometer 222 can procure orientation data of the robotic body 201, when operating on inclined surfaces, such as tilted PV modules 12 or other tracker components, and such orientation data can help the solar tracker system to identify motor torque and speed adjustment dynamically to maintain optimal grip and prevent slippage. As another example, accelerometer 222 can procure orientation data of the robotic body 201 to detect subtle and repetitive tilt anomalies which may suggest micro-level defects such as: raised PV module frames, loose or protruding fasteners, and/or localized PV module warping. As another example, accelerometer 222 can procure orientation data of the robotic body 201 to detect angular deviations during normal linear movement of robotic body 201 which can indicate misaligned PV modules and/or or uneven mounting structures along the row which the robotic body 201 traverses, which may require further maintenance. As another example, accelerometer 222 can procure orientation data of the robotic body 201 to detect a sudden or excessive tilt at the solar tracker at which the robotic body 201 is positioned which can trigger an emergency stop or retraction mechanisms at the robotic body 201 to help prevent the robotic body 201 from tipping over or sliding off the PV module. As another example, accelerometer 222 can procure orientation data of the robotic body 201 to detect robotic body 201 orientation relative to a programmed inclination angle for the row that the robotic body 201 traverses along so as to help maintain a generally orthogonal orientation of maintenance solution (e.g., coating) applicator to the PV module surface which can help to deposit a relatively uniform thickness coating along that PV module surface. Additionally or alternative to one or more (e.g., each) of these examples, orientation data of the robotic body 201 procured by the accelerometer 222 can be correlated with PV module layout and ground terrain elevational changes to predict and flag areas of the solar tracker that can be experiencing higher wear-and-tear potential or infrastructure degradation as compared to other areas of the tracker having different orientation data of the robotic body 201 procured by the accelerometer 222.

In one exemplary application of the accelerometer, the accelerometer's data corresponding to the present orientation of the robotic body 201 can be used to detect twisting of the solar tracker's torque tube about the central longitudinal axis of the torquer tube. And when such detected twisting of the torque tube exceeds a predetermined magnitude/extent from the solar tracker's programmed inclination angle of the torque tube, the programmable processor (e.g., of the solar tracker inspection module 195) can generate the solar tracker defect indication as corresponding to a presence of twisting of the torque tube about its central longitudinal axis. In some such applications, this defect indication can be a type of control command that, when provided, causes the solar tracker to rotate the torque tube about its central longitudinal axis to reduce the extent of detected twist of the torque tube about its central longitudinal axis.

For example, the solar tracker's torque tube can be programmed at a given time of the day to be at a thirty degree inclination angle (e.g., such that the solar modules mounted to the torque tube are oriented at a thirty degree inclination angle). At this time, when the robotic body 201 traverses along the solar module(s) mounted to the torque tube at this programmed inclination angle, the accelerometer at the robotic body 201 can be used to procure multi-axis orientation data which can correspond to the present inclination angle of the torque tube for the region of the solar tracker at which the robotic body 201 is currently located. Thus, the received multi-axis orientation data from the accelerometer, relating to the present orientation of the torque tube when the robotic body is at the solar tracker, can be compared to the programmed inclination angle of the torque tube. If the received sensor data from the accelerometer differs from the programmed inclination angle of the torque tube, for instance by a predetermined extent, this can indicate the presence of twisting about the longitudinal axis of the torque tube and execution of the computer-readable instructions can cause the programmable processor to provide the solar tracker defect indication. For example, the received sensor data from the accelerometer may indicate that the robotic body 201 is currently oriented at thirty five degrees whereas the programmed inclination angle would otherwise mean that the robotic body would be expected to be at or near the thirty degree programmed inclination angle, thus indicating the presence of twisting about the central longitudinal axis of the torque tube. In addition to or alternative to providing the solar tracker defect indication, if the received sensor data from the accelerometer differs from the programmed inclination angle of the torque tube, for instance by a predetermined extent, execution of the computer-readable instructions can cause the programmable processor to transmit a control command for the solar tracker to rotate the torque tube to change the orientation of the torque tube to reduce twisting of the torque tube about the longitudinal axis of the torque tube. In this example noted, this could include causing the solar tracker to rotate the torque tube by approximately the five degree discerned difference to thereby remediate the twisting of the torque tube and more optimally orient the solar tracker to increase power generation.

As a further example shown at FIGS. 3B and 3C, the sensor device 219 can include a proximity sensor 223. For instance, the sensor device 219 can include the proximity sensor 223 in addition to, or alternative to, imaging device(s) 220 and/or the accelerometer 222. In such cases, the sensor data received from the proximity sensor 223 can relate to: (i) a first distance between the proximity sensor 223 and the at least one solar tracker component at a first time when the robotic body 201 is at the solar tracker component, and (ii) a second distance between the proximity sensor 223 and the at least one solar tracker component at a second, different time when the robotic body 201 is at the solar tracker component. Such component can be a solar tracker component at the first side 101 and/or second side 102. As one example, the solar tracker component can be a fastening member 13a (e.g., bolt, screw, rivet, clip, etc.) at the second side 102. According to this example, the proximity sensor 223 can capture proximity data relating to the fastening member 13a at different times to discern whether the fastening member 13a has changed positions (e.g., changed position relative to torque tube 14) over the time period. As such, in this example, the sensor data received from the proximity sensor 223 can relate to: (i) a first distance between the proximity sensor 223 and the fastening member 13a at a first time when the robotic body 201 is at the solar tracker component, and (ii) a second distance between the proximity sensor 223 and the at fastening member 13a at a second, different time when the robotic body 201 is at the solar tracker component. The at least one predetermined solar tracker component threshold can, thus, include a predetermined magnitude of change between the first distance and the second distance such that, when executed by the programmable processor, the instructions cause the programmable processor to provide the solar tracker defect indication when the sensor data received from the proximity sensor 223 meets the predetermined magnitude of change. This can similarly be executed for other solar tracker components, such as PV module 12. As one example, proximity data procured by the robotic body 201 can be used to identify faults along the tracker row, such as detecting PV modules edges and gaps between PV modules, enabling the robotic body 201 to adjust its movement along the row to avoid falling off or stopping at the correct position before transitioning between PV modules. As another example, proximity data procured by the robotic body 201 can be used to detect nearby obstructions, such as bird droppings, debris piles, or structural elements like mounting brackets, and automatically trigger directional path and/or speed adjustments of the robotic body 201 to reduce or avoid damage. As another example, proximity data procured by the robotic body 201 can be used to generate a contour map along a surface of one or more solar tracker components, for instance, by mapping a height profile along the path the robotic body traverses along the row and, when detected deviations beyond a predetermined extent, can be used to indicate defects, such as PV module surface warping, raised debris, or deformation and/or height mismatches or misalignment amongst multiple solar tracker components (e.g., from one PV module to the next PV module). As another example, proximity data procured by the robotic body 201 can be used to measure a distance between a brush member at the robotic body 201 and a surface of a PV module to be swept by the brush member to help maintain optimal brush member pressure at the PV module without resulting undue abrasion to the PV module surface. As another example, proximity data procured by the robotic body 201 can be used to help the robotic body 201 avoid sensitive areas along the tracker row, such as junction boxes, PV module frames, or wiring harnesses where direct mechanical contact may cause damage. As another example, proximity data procured by the robotic body 201 can be used to maintain a specified distance between a maintenance solution applicator at the robotic body 201 and a surface of a PV module at which the maintenance solution applicator is to apply a maintenance solution (e.g., coating material, air, liquid detergent, etc.).

The inclusion of the brush assembly 210 can be useful in increasing the accuracy of the sensor device 219, such as the proximity sensor 223 or other sensor members. As shown for the illustrated example, the proximity sensor 223 can be spaced apart from the brush member 241 in or both directions of travel of the robotic body 201, for instance, such that the brush member 241 can lead of trail the proximity sensor 223 in the direction of travel of the robotic body 201. The embodiment here shows the proximity sensor 223 can include a plurality of proximity sensing members 223 disposed along a first axis 125 relative to the robotic body 201, and the brush assembly 210 (e.g., brush member 241) can be disposed along a second axis 126 relative to the robotic body 201, with this second axis 126 spaced apart from in the direction of travel and parallel to the first axis 125. For instance, where the inspecting solar tracker component includes PV module 12, the proximity sensor 223 can be disposed at the robotic body 201 to capture the sensor data after the brush member 241 has passed over the PV module 12. In this way, the brush member 241 can sweep off particulate at the PV module 12 or other component to enable a more accurate proximity measurement via the proximity sensor 223.

Additionally or alternatively, to help with increasing the accuracy of sensor data collection, the system 200 can be configured to execute one or more calibrations to account for one or more ambient conditions at the solar tracker at the time of inspection. For example, when executed by the programmable processor, the programmed instructions can cause the programmable processor to calibrate the sensor device 219 based on at least one environmental condition ambient to the robotic body 201. One exemplary such environmental condition ambient to the robotic body 201 to which the sensor device 219 can be calibrated is sun light. In this example, when executed by the programmable processor, the instructions (e.g., at module 195) can further cause the programmable processor to determine a presence of solar light irradiance at the PV module 12 exceeding a predetermined irradiance threshold, and, when the presence of solar light irradiance at the photovoltaic module is determined to exceed a solar light irradiance threshold, adjust an orientation of the sensor device 219 (e.g., rotated, pivoted, etc.), relative to the robotic body 201, to reduce solar light irradiance captured by the sensor device 219. Another exemplary such environmental condition ambient to the robotic body 201 to which the sensor device 219 can be calibrated is one or more present weather conditions. In this example, when executed by the programmable processor, the instructions (e.g., at module 195) can further cause the programmable processor to weather data relating to an ambient weather condition at the solar tracker and save the weather data in association with the provided solar tracker defect indication. In some cases, the weather data can be received from a weather sensing device (e.g., a wind speed detector) onsite at the solar tracker and processed at the module 195. Saving such weather data in association with the data captured by the sensor device 219 can provide helpful context is assessing a defect indication and/or planning for future remediation efforts to reduce future impact of such weather conditions at the solar tracker.

The illustrated embodiment of the robotic body 201 at FIGS. 3A-3C can also include attachment mechanism 207. The attachment mechanism 207 can be configured to movably attach the robotic body 201, directly or indirectly, to one or more solar tracker components, such as to one or more PV modules 12, such as one or more PV modules 12 along the row 120d. The attachment mechanism 207 can attach the robotic body 201, directly or indirectly, to one or more PV modules 12 such that the robotic body 201 can move along the one or more PV modules 12 (e.g., move along the row 120d via relative movement between the attachment mechanism 207 and the PV modules 12 of the row 120d). The example here shows the attachment mechanism 207 movably coupling the robotic body 201 to a frame portion of PV module 12 such that the robotic body 201 can move along frame portions of PV modules 12 to execute one or more sensor data acquisition and/or maintenance operations at the PV modules 12 as the robotic body 201 moves there along. The attachment mechanism 207 can include a first attachment mechanism at a first side of the robotic body 201 configured to attach directly to a first end portion of the PV module 12 and a second attachment mechanism at a second, opposite side of the robotic body 201 configured to attach directly to a second, opposite end portion of the PV module 12.

For some further embodiments, the robotic body 201 of the system 200 can be configured to perform one or more maintenance operations at one or more solar tracker components. For such embodiments, the robotic body 201 can include maintenance solution applicator 206 that is configured to apply one or more maintenance solutions at one or more solar tracker components. The maintenance solution applicator 206 can be coupled to the controller 203, and the controller 203 can be configured to cause the motive source to apply a motive force to the one or more wheels 205 to cause the robotic body 201 to move relative to one or more PV modules 12. And, the controller 203 can be configured to actuate the maintenance solution applicator 206 to cause one or more maintenance solutions (e.g., a coating material and/or a fluid cleaning solution) to be output onto the one or more PV modules 12 or other solar tracker component. For example, the controller 203 can be configured to move the robotic body 201 along one or more PV modules 12 (e.g., along row 120d) and to output one or more maintenance solutions from the maintenance solution applicator 206 at an output rate corresponding to the speed at which the controller 203 moves the robotic body 201 along one or more PV modules 12. This can be helpful in outputting a desired about of maintenance solution at a given area at one or more PV modules 12. In one example, the maintenance solution applicator 206 at robotic body 201 can include a coating applicator that is configured to output a coating material onto a surface of PV module 12. In another example, the maintenance solution applicator 206 at robotic body 201 can include a fluid cleaning solution applicator that is configured to output a fluid cleaning solution (e.g., pressurized air and/or liquid detergent solution, such as atomized liquid detergent solution) onto a surface of PV module 12. In yet another example, the maintenance solution applicator 206 at robotic body 201 can include both a coating applicator and a fluid cleaning solution applicator.

In addition to the robotic body 201, the system 200 can also include one or more maintenance solution reservoirs 202, such as a coating material reservoir and/or fluid cleaning solution reservoir. The one or more reservoirs 202 can be configured to supply one or more maintenance solutions, such as one or more coating materials and/or one or more cleaning solutions, respectively, to the maintenance solution application 206 (e.g., the coating applicator and/or the cleaning solution applicator, respectively). In some examples, the one or more reservoirs 202 can be carried at the robotic body 201. But in other examples, such as shown at FIG. 3A, the one or more reservoirs 202 can be in fluid communication with the maintenance solution applicator 206 but offboard, and thus remote from, the robotic body 201. In such examples where the one or more reservoirs 202 are offboard the robotic body 201, the one or more reservoirs 202 can be carried at a mobile cart 230 that is movable (e.g., with the robotic body 201), with the one or more reservoirs 202 in fluid communication between the mobile cart 230 and the maintenance solution applicator 206. Thus, the offboard reservoir 202 can be disposed on mobile cart 230 accompanying the robotic body 201.

Whether onboard or offboard the robotic body 201, the reservoir 202 can be in fluid communication with the maintenance solution applicator 206 at the robotic body 201. The reservoir 202 can be in fluid communication with the applicator 206 to thereby supply one or more mediums from the reservoir 202 to the applicator 206.

For example, the controller 203 can be configured to execute instructions to cause the controller 203 to: after the robotic body 201 has applied a maintenance solution to the PV module 12, use the received data from the sensor device 219, relating to one or more solar tracker components, to evaluate positioning of the one or more solar tracker components that have been cleaned by the maintenance solution applicator 206.

For example, the controller 203 can cause one or more coating materials to be conveyed from the reservoir 202 to coating applicator 206 such that the robotic body 201 is configured to apply the one or more coating materials, via the coating applicator 206, to one or more photovoltaic modules or other solar tracker component(s). Thus, the robotic body 201, via the controller 203 and coating applicator 206, can be configured to deposit a hydrophobic coating onto one or more PV modules 12. For instance, the robotic body 201, via the controller 203 and coating applicator 206, can be configured to deposit a hydrophobic coating over photovoltaic cells at one or more PV modules 12 such that the photovoltaic cells are overlaid by a hydrophobic coating layer. The robotic body 201 can do so as the robotic body 201 moves along the PV modules 12, for instance, via the robotic body 201 traversing along a given row of a solar tracker to deposit such a coating at the PV modules along that given row. As a result of the applied coating, the PV modules of the row may be imparted with an enhanced ability to repel ambient airborne particulate from the surface of the PV modules to thereby reduce or prevent energy generation obstruction. The sensor device 219 can then be used to acquire thermal data relating to the PV module to assess the applied coating layer at the PV module 12 and/or relative positioning of one or more solar tracker components. A similar operation can be executed simultaneously, sequentially, alternatively, or independently using a fluid maintenance solution (e.g., pressurized air, liquid detergent, both, etc.) conveyed from reservoir 222 to applicator 206.

As noted, in some examples, the robotic body 201 can additionally include one or more brush assemblies 210 coupled to, and controllable by, the controller 203. Each of the one or more brush assemblies 210 can include brush member 241 that can be rotatably driven, about a rotational axis, in direction(s) 103, 104, and relative to the robotic body 201 to sweep, buff, polish, or perform other brush-related maintenance task at PV module 12. The one or more brush assemblies 210 can be configured to perform one or more maintenance operations at one or more PV modules 12, for instance, in coordination with the maintenance solution applicator 206 (e.g., in coordination with the coating applicator and/or the cleaning solution applicator). For example, the one or more brush assemblies 210 can be configured to contact a given PV module 12 and to perform at least one maintenance task at the contacted surface of the PV module 12. Such maintenance tasks performed by the one or more brush assemblies 210 can vary depending on the application of the maintenance solution applicator 206.

For example, when the robotic body 201 is configured to apply one or more coating materials, via the coating applicator 206, to the photovoltaic module as the robotic body moves along the photovoltaic module, the one or more brush assemblies 210 can perform a cleaning function and/or a coating finishing function. For example, when the robotic body 201 moves in direction 189 along a tracker row such that at least one brush assembly 210 is disposed at the robotic body 201 to lead the coating applicator 206, the at least one brush assembly 210 leading the coating applicator 206 can first perform a sweeping function to remove particulate at a given surface area of a given PV module followed by the coating applicator 206 then depositing one or more coating materials at the same given area of the given PV module after it has been swept. And, before, during, and/or after sweeping and/or coating material deposition at a given PV module, the sensor device 219 can acquire data relating to a current position of one or more solar tracker components. This order of maintenance operations can be useful in improving the adherence of the coating material at the swept PV module surface. As another example, when the robotic body 201 moves in direction 190 along a tracker row such that the coating applicator 206 is disposed at the robotic body 201 to lead the at least one brush assembly 210, the at least one brush assembly 210 trailing the coating applicator 206 can perform a coating finishing function at the deposited coating material after the coating applicator 206 has deposited the coating material at a given surface area of a PV module. As a yet further example, where the robotic body 201 includes a first brush assembly and second, different brush assembly, first brush assembly can be disposed to lead the coating applicator 206 and thus first brush assembly can perform the leading sweeping function ahead of the coating applicator 206 while the second brush assembly can be disposed to trail the coating applicator 206 and thus the second brush assembly can perform the trailing coating finishing function behind the coating applicator 206.

As noted, in some embodiments, the maintenance solution applicator 206 can include a cleaning solution applicator in addition, or alternative, to the coating applicator. Thus, in such embodiments, the robotic body 201 can perform maintenance tasks at PV modules including coating applications and fluid cleaning solution applications. Fluid cleaning solution applications can include output of one or more fluid cleaning solutions (e.g., pressurized air and/or liquid detergent solution, such as atomized liquid detergent solution) at a PV module or other solar tracker component. For instance, the inspection system 200 can include cleaning solution applicator 206 carried at robotic body 201, in addition to or alternative to a coating applicator.

As also shown at FIG. 3A, the robotic body 201 can further include one or more valves 212 in fluid communication between the maintenance solution applicator 206 and the one or more reservoirs 202. The one or more valves 212 can be coupled to, and controllable by, the controller 203. For example, each of the one or more valves 212 can be controllable by the controller 203 to alter a fluid pressure and a fluid velocity of the coating material and/or fluid cleaning solution output from the applicator 206. This could include the controller 203 altering a fluid pressure and a fluid velocity of the coating material and/or fluid cleaning solution output from the applicator 206 as a function of one or more measurable operating characteristics detected by the sensor device 219 at robotic body 201. For example, the controller 203 can be configured to alter the fluid pressure and a fluid velocity output from the applicator 206 as a function of the speed at which the controller 203 moves the robotic body 201 along one or more PV modules (e.g., along row 120d). Some embodiments can additionally include at the robotic body 201 one or more flow meters coupled to the controller 203 and in fluid communication with the applicator 206.

As one exemplary such application, the controller 203 can be configured to adjust an output flow rate of a maintenance solution (e.g., coating material and/or fluid cleaning solution) from the applicator 206 when detected wind speed ambient to the vehicle body 201 exceeds a predetermined wind speed threshold. This can help to optimize adherence of the maintenance solution and/or reduce waste associated with output solution that may migrate off target as a result of the ambient wind force.

Other additional or alternative examples can include the robotic body 201 having one or more light sensors, one or more flowmeters (e.g., associated with the applicator 206), and/or one or more temperature sensors (e.g., associated with the reservoir 202). For instance, as one exemplary application, when the temperature associated with the reservoir 202 is below a predetermined temperature threshold, the controller 203 can be configured to adjust (e.g., reduce, such as terminate) an output of the solution from the reservoir 202. Such one or more temperature sensors at the robotic body can be useful in detecting one or more solar tracker defects. For example, abnormal temperature readings across a given PV module surface can indicate localized hotspots, which are often a result of: cell-level defects (e.g., microcracks or delamination); soiling patterns (e.g., bird droppings causing heating under sunlight); and/or faulty bypass diodes or shading issues. Such temperature readings at a given PV module via the robotic body 201 can be logged and used to assess preventative maintenance relating to that PV module. As another example, temperature readings at the robotic body 201 can be used to monitor operational health of robotic body component(s), such as the motor, wheels, and bearing components, which can help to detect early signs of degradation and enable predictive, preventative maintenance (e.g., when temperature at robotic body 201 differs from a predetermined temperature threshold, robotic body 201 can pause or terminate operation until the temperature at robotic body 201 falls back within the predetermined temperature threshold). As another example, temperature readings at the robotic body 201 can be used to inform maintenance solution output from the robotic body, such as to adjust maintenance solution output pressure and flow rate to avoid damaging the PV module, such as during relatively high thermal expansion time periods (e.g., peak sunlight hours) and/or relatively low thermal expansion time periods (e.g., frost or dew present at PV module). As another example, temperature readings at the robotic body 201 can be used to determine one or more operational parameters for coating material application, which may require specified temperature range at the PV module for proper coating material adhesion thereat. As another example, temperature readings at the robotic body 201 can be used with other ambient, environmental data at the robotic body 201 (e.g., wind, dust accumulation patterns) to inform when and where to deploy the robotic body 201 to execute a maintenance operation.

The embodiments of the PV robotic cleaning system 200 described herein can, for instance, be configured as an autonomous or semi-autonomous system 200 that is configured to autonomously, or semi-autonomously, acquire data from the sensor device 219 relating to one or more installed components at the solar tracker to thereby inspect an installed configuration of such one or more components when the robotic body is at the location of such one or more components along the row. For example, the system 200 can be configured to execute self-driven movement of the robotic body 201 along PV modules 12 at a tacker row 120d while autonomously executing one or more sensor data acquisition and/or maintenance tasks at such PV modules 12. The system 200 can, in some examples, thus form a closed-loop feedback and control system 200 operable to autonomously execute one or more inspection and/or maintenance tasks while the robotic body 201 moves relative to the solar tracker.

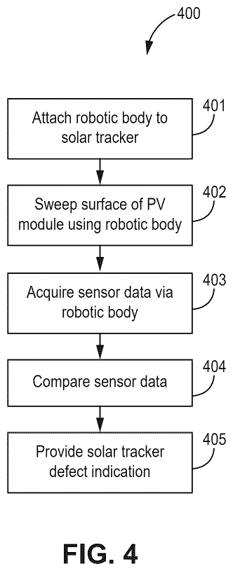

FIG. 4 is a flow diagram of an embodiment of method 400 of inspecting a solar tracker. In some examples, the method 400 can be executed, at least in part, using any one of the features disclosed elsewhere herein. For instance, the method 400 could be executed by embodiments of the robotic inspection system disclosed elsewhere herein.

At step 401, the method 400 includes attaching a robotic body to the solar tracker. For example, this can include attaching the robotic body to the solar tracker such that one or more wheels at the robotic body contact the solar tracker (e.g., contact one or more PV modules). This could include using one or more features of the attachment mechanism at the robotic body as disclosed elsewhere herein. For instance, the robotic body can be movably attached at each of opposite sides of a row of the solar tracker.

At step 402, the method 400 includes sweeping a surface of a PV module of the solar tracker using a brush assembly at the robotic body while moving the robotic body along the solar tracker, for instance along the PV module.

At step 403, the method 400 includes, while moving the robotic body along the solar tracker, using a sensor device at the robotic body to acquire sensor data relating to at least one component of the solar tracker, such as at least one component other than the PV module. This can include using one or more of a camera, accelerometer, and proximity sensor of the sensor device at the robotic body to capture sensor data relating to at least one component of the solar tracker, such as at a component positioned between a ground surface and a surface of the PV module having PV cells. In one example, the sensor device can acquire such data after the robotic body has been used to sweep the surface of the PV module using the brush assembly.

At step 404, the method 400 includes comparing the sensor data to at least one predetermined solar tracker component threshold. For example, the at least one solar tracker component to which the captured sensor data relates can include at least one of: a wire harness, a cable string, a torque tube, a fastener, and a ground support. And the at least one predetermined solar tracker component threshold can include a predetermined position of that solar tracker component relative to a another, different solar tracker component of the solar tracker and/or a change in position over time of that solar tracker component of the solar tracker. Such comparison can enable discerning potential defects, at the present time or at a predicted future time, associated with intended installation of solar tracker components at the solar tracker—whether defective at initial installation or becoming/predicted to become defective over an operating time period of the solar tracker.

At step 405, the method 400 includes, when the sensor data meets the at least one predetermined solar tracker component threshold, providing a solar tracker defect indication. Such solar tracker defect indication can indicate an erroneous component installation at the solar tracker and/or a defective migration of the component over time relative to other components at the solar tracker.

Further embodiments of the method 400 can include one or more additional steps. As one example, the method 400 can include the steps of: determining solar light irradiance at the solar tracker exceeding a predetermined irradiance threshold; and when the solar light irradiance at the solar tracker is determined to exceed the predetermined irradiance threshold, adjusting an orientation of the sensing device (e.g., visible light camera), relative to the robotic body, to reduce solar light irradiance noise captured by the sensing device. As another example, the method 400 can include one or more steps relating to execution of a maintenance operation, such as application of a maintenance solution, such as disclosed elsewhere herein.

Various non-limiting exemplary embodiments have been described. It will be appreciated that suitable alternatives are possible without departing from the scope of the examples described herein.

What is claimed is:

1. A robotic inspection system comprising:
a robotic body comprising: a controller, a motive source coupled to the controller, a sensor device coupled to the controller, a brush assembly coupled to the controller, and an attachment mechanism for attaching the robotic body to a solar tracker such that the robotic body is configured to move along the solar tracker with the brush assembly disposed to interface with a first side of the solar tracker; and
a solar tracker inspection module in communication with the sensor device, the solar tracker inspection module comprising: a programmable processor and a non-transitory computer-readable medium storing instructions that, when executed by the programmable processor, cause the programmable processor to:
receive, from the sensor device, sensor data related to at least one solar tracker component of the solar tracker,
compare the received sensor data to at least one predetermined solar tracker component threshold, and
when the received sensor data meets the at least one predetermined solar tracker component threshold, provide a solar tracker defect indication.

2. The system of claim 1, wherein the sensor device comprises an imaging device, and wherein the sensor data received from the imaging device comprises visible light image data that relates to the at least one solar tracker component.

3. The system of claim 2, wherein the imaging device is disposed at the robotic body to capture the visible light image data at least at a second side of the solar tracker, the second side opposite the first side.

4. The system of claim 3,
wherein the imaging device comprises a first visible light camera and a second visible light camera,
wherein the first visible light camera is disposed at a first side of the robotic body such that the first visible light camera is configured to capture first visible light image data at least of the second side of the solar tracker in an eastward-facing direction, and
wherein the second visible light camera is disposed at a second, opposite side of the robotic body such that the second visible light camera is configured to capture second visible light image data at least of the second side of the solar tracker in a westward-facing direction.

5. The system of claim 4, wherein the solar tracker inspection module is configured to combine the first visible image data with the second visible image data to form a composite visible light data map that comprises the at least one solar tracker component at the second side of the solar tracker.

6. The system of claim 5, wherein the brush assembly comprises a brush member, and wherein the brush member extends from a first brush end of the brush member adjacent to the first visible light camera to a second, opposite brush end of the brush member adjacent to the second visible light camera.

7. The system of claim 3,
wherein the at least one solar tracker component at the second side of the solar tracker is a first solar tracker component that comprises at least one of: a wire harness, a cable string, a torque tube, a fastener, and a ground support, and
wherein the at least one predetermined solar tracker component threshold comprises a predetermined position of the first solar tracker component relative to a second, different solar tracker component that is at the second side of the solar tracker.

8. The system of claim 1, wherein the sensor device comprises an accelerometer, and wherein the sensor data received from the accelerometer relates to an orientation of the at least one solar tracker component.

9. The system of claim 8,
wherein the at least one solar tracker component comprises a photovoltaic module of the solar tracker,
wherein the at least one predetermined solar tracker component threshold comprises data relating a programmed inclination angle of the photovoltaic module when the robotic body is at the photovoltaic module, and
wherein, when executed by the programmable processor, the instructions cause the programmable processor to compare the received sensor data from the accelerometer, relating to the orientation of the photovoltaic module when the robotic body is at the photovoltaic module, to the programmed inclination angle, and
when the received sensor data from the accelerometer differs from the programmed inclination angle of the photovoltaic module, the instructions cause the programmable processor to provide the solar tracker defect indication.

10. The system of claim 8,
wherein the at least one solar tracker component comprises a torque tube of the solar tracker,
wherein the at least one predetermined solar tracker component threshold comprises data relating a programmed inclination angle of the torque tube when the robotic body is at the solar tracker, and
wherein, when executed by the programmable processor, the instructions cause the programmable processor to compare the received sensor data from the accelerometer, relating to the orientation of the torque tube when the robotic body is at the solar tracker, to the programmed inclination angle of the torque tube, and
when the received sensor data from the accelerometer differs from the programmed inclination angle of the torque tube, the instructions cause the programmable processor to provide the solar tracker defect indication.

11. The system of claim 10, wherein, when the received sensor data from the accelerometer differs from the programmed inclination angle of the torque tube beyond a predetermined extent, the instructions cause the programmable processor to provide the solar tracker defect indication corresponding to twisting of the torque tube along a longitudinal axis of the torque tube.

12. The system of claim 8,
wherein the at least one solar tracker component comprises a torque tube of the solar tracker,
wherein the at least one predetermined solar tracker component threshold comprises data relating a programmed inclination angle of the torque tube when the robotic body is at the solar tracker, and
wherein, when executed by the programmable processor, the instructions cause the programmable processor to compare the received sensor data from the accelerometer, relating to the orientation of the torque tube when the robotic body is at the solar tracker, to the programmed inclination angle of the torque tube, and
when the received sensor data from the accelerometer differs from the programmed inclination angle of the torque tube beyond a predetermined extent, the instructions cause the programmable processor to transmit the solar tracker defect indication as corresponding to a control command for the solar tracker to rotate the torque tube to change the orientation of the torque tube to reduce twisting of the torque tube along a longitudinal axis of the torque tube.

13. The system of claim 1, wherein the sensor device comprises a proximity sensor, and wherein the sensor data received from the proximity sensor relates to: (i) a first distance between the proximity sensor and the at least one solar tracker component at a first time when the robotic body is at the solar tracker component, and (ii) a second distance between the proximity sensor and the at least one solar tracker component at a second, different time when the robotic body is at the solar tracker component.

14. The system of claim 13, wherein the at least one predetermined solar tracker component threshold comprises a predetermined magnitude of change between the first distance and the second distance such that, when executed by the programmable processor, the instructions cause the programmable processor to provide the solar tracker defect indication when the sensor data received from the proximity sensor meets the predetermined magnitude of change.

15. The system of claim 14, wherein the at least one solar tracker component comprises a photovoltaic module, wherein the brush assembly comprises a brush member, and wherein the proximity sensor is disposed at the robotic body to capture the sensor data after the brush member has passed over the photovoltaic module.

16. The system of claim 13, wherein the proximity sensor comprises a plurality of proximity sensing members disposed along a first axis relative to the robotic body, and wherein the brush assembly is disposed along a second axis relative to the robotic body, the second axis parallel to the first axis.

17. The system of claim 1, wherein, when executed by the programmable processor, the instructions further cause the programmable processor to: calibrate the sensor device based on at least one environmental condition ambient to the robotic body.

18. The system of claim 17, wherein, when executed by the programmable processor, the instructions further cause the programmable processor to:
determine a presence of solar light irradiance at the photovoltaic module exceeding a predetermined irradiance threshold, and
when the presence of solar light irradiance at the photovoltaic module is determined to exceed a solar light irradiance threshold, adjust an orientation of the sensor device, relative to the robotic body, to reduce solar light irradiance captured by the sensor device.

19. The system of claim 1, wherein, when executed by the programmable processor, the instructions further cause the programmable processor to:
receive weather data relating to an ambient weather condition at the solar tracker and save the weather data in association with the solar tracker defect indication.

20. The system of claim 1, wherein the solar tracker inspection module is at a server remote from the robotic body, and wherein the sensor device is in wireless data communication with the solar tracker inspection module.

21. The system of claim 1, wherein the robotic body further comprises a maintenance solution applicator configured to apply a maintenance solution, via the maintenance solution applicator, to the solar tracker, wherein the maintenance solution applicator comprises a plurality of nozzles disposed along a first axis relative to the robotic body, and wherein the brush assembly is disposed along a second axis relative to the robotic body, the second axis parallel to the first axis.

22. A method of inspecting a solar tracker, the method comprising the steps of:
attaching a robotic body to the solar tracker;
sweeping a surface of a photovoltaic module of the solar tracker using a brush assembly at the robotic body while moving the robotic body along the solar tracker;
while moving the robotic body along the solar tracker, using a sensor device at the robotic body to acquire sensor data relating to at least one component of the solar tracker other than the photovoltaic module;
comparing the sensor data to at least one predetermined solar tracker component threshold; and
when the sensor data meets the at least one predetermined solar tracker component threshold, providing a solar tracker defect indication.
